(19) United States
(12) Patent Application Publication
(10) Pub. No.: US 2025/0026015 A1
(43) Pub. Date: Jan. 23, 2025

(54) MIXED REALITY ROBOTIC TRAINING SYSTEM AND METHODS

(71) Applicant: ABB SCHWEIZ AG, Baden (CH)

(72) Inventors: Tommy Y. Svensson, Auburn Hills, MI (US); Ekhi Laniesse, Cergy (FR)

(21) Appl. No.: 18/906,007

(22) Filed: Oct. 3, 2024

Related U.S. Application Data
(63) Continuation of application No. PCT/IB2022/000244, filed on Apr. 4, 2022.

(51) Int. Cl. B25J 9/16

(52) U.S. Cl. CPC B25J 9/1671; B25J 9/1689

(57) ABSTRACT

A robotic training system includes a first computing device and a mixed reality device. The first computing device includes a first program to control the mixed reality device. The first program also includes a simulated robot operating in a simulated environment and instructions for a mixed reality robot to be displayed by the mixed reality device. The first computing device can receive an input and determine instructions to control the simulated robot and determine instructions to control the mixed reality robot based on the input. The simulated robot can be viewed on a first display of the first computing device and the mixed reality robot can be viewed on the mixed reality device. Further, the first computing device can connect to a second computing device to train the user of the first computing device to operate an industrial robot. The second computing device can be connected to a physical robot.

### FIELD

The present disclosure relates to the field of robotic systems, and more particularly, to industrial robot training systems using mixed reality.

### BACKGROUND

Robotic systems have widespread applications in a variety of industries, including automotive, aerospace, electronics, medical, and other fields, which use robotic systems to improve efficiency and streamline operations. To operate these robotic systems, programmers and operators require in-depth training. Typically, training includes learning how to control the physical robots through observation of robot behavior based on inputs into a robot controller. These systems can also include virtual simulator programs that operate in a simulated environment in the computer to simulate robot operation or to program operation of the physical robot based on the simulated robot.

The ability to observe how the robot operates based on the user input, observing how the robot will operate in in a particular physical space, and being able to train on a wide variety of robot models can be useful tools for users. However, coordinating training on these systems can be costly and logistically difficult. Either the users have to go to the training facility, or the robot has to shipped to the customer location. If multiple robots are being used, then each additional robot can further increase the cost. Also, these robots take up a large amount of physical space.

The global pandemic has further altered the above considerations. Many employers have adopted remote work strategies due to shifting social distancing requirements and other reasons. Therefore, users may not be located at one central location to be trained on the robotic system. This unprecedented new paradigm has raised additional obstacles in training users on the robotic systems. Accordingly, improved robotic training systems are desirable.

### SUMMARY

In some embodiments, a method of operating a mixed reality robotic training system, the mixed reality robotic training system including a first computing device and a mixed reality device, the method includes: obtaining the first computing device including a processor, a non-transitory computer-readable medium having stored thereon instructions executable by the processor, a first program, a touchscreen display, and a user input interface; obtaining the mixed reality device including a camera and a second display; displaying, by the mixed reality device, a scene of the mixed reality robot on the second display based on a simulated robot; receiving, by the first computing device, a first input on the user input interface to control an operation of the mixed reality robot at the touchscreen display; determining, by the first computing device, a first instruction to control the mixed reality robot based on the first input; transmitting, by the first computing device, the first instruction to control the operation of the mixed reality robot in the scene to the mixed reality device; and displaying, by the mixed reality device, the operation of the mixed reality robot based on the first instruction in the scene on the second display.

In some embodiments, the method further includes: displaying, by the first computing device, a first image identifying the first computing device on the first display; capturing, by the mixed reality device, the first image with the camera; and connecting the mixed reality device to the first computing device.

In some embodiments, the method further includes: displaying, by the mixed reality device, a command log of the first computing device in the scene of the mixed reality robot.

In some embodiments, controlling a movement of the mixed reality robot based on the first input further includes: controlling, by the first computing device, the operation of the simulated robot based on the first instruction; and determining, by the first computing device, the operation of the mixed reality robot based on the first instruction.

In some embodiments, the robotic training system further includes a second computing device, wherein the second computing device includes a processor, a non-transitory computer-readable medium having stored thereon instructions executable by the processor, a second program, and wherein the method further includes: obtaining a second computing device, connecting the first computing device to the second computing device; receiving, by the second computing device, the first instruction from the first computing device; and displaying, by the second computing device, the operation of the simulated robot in the second program based on the first instruction.

In some embodiments, the robotic training system further includes an industrial robot, and the method further includes: connecting the industrial robot to the second computing device; controlling, by the second computing device, the operation of the industrial robot based on the first instruction from the first computing device.

In some embodiments, the method further includes: receiving, by the second computing device, a second input at the second computing device; determining, by the second computing device, a second instruction to control the operation of the simulated robot; transmitting, by the second computing device, the second instruction to the first computing device to control the operation of the simulated robot and the mixed reality robot; and controlling, by the first computing device, the operation of the simulated robot and the mixed reality robot based on the second instruction.

In some embodiments, the method further includes: capturing, by the mixed reality device, a plurality of images of an object in the scene of the mixed reality robot and transmitting the plurality of images to the first computing device; determining, by the first computing device, an interaction between the object and the mixed reality robot based on the plurality of images; determining, by the first computing device, a third instruction based on an interaction of the object with the mixed reality robot; controlling, by the first computing device, the operation of the simulated robot and the operation of the mixed reality robot based on the third instruction; displaying, by the mixed reality device, the operation of the mixed reality robot based on the third instruction.

In some embodiments, the method further includes: determining, by the first computing device, a boundary associated with the mixed reality robot, displaying, by the mixed reality device, the boundary when the object approaches the boundary; wherein determining the interaction between the object and the mixed reality robot includes determining the object interaction with the boundary.

In some embodiments, the object includes a hand of a user; and wherein the interaction includes a hand gesture.

In some embodiments, a method for remote operation of a mixed reality robot training system, the robotic training system including a first computing device and a mixed reality device, the first computing device including a processor, a non-transitory computer readable medium having stored thereon instructions executable by the processor, a first program, and a first display, and wherein the mixed reality device includes camera and a second display, the first computing device and the mixed reality device at a first location, the method includes: receiving, by the first computing device, an input to command a simulated robot of the first program; determining, by the first computing device, a first instruction to control the operation of the simulated robot and a second instruction to control the operation of the mixed reality robot based on the input; controlling, by the first computing device, the operation of the simulated robot based on the first instruction and the operation of the mixed reality robot based on the second instruction; transmitting, by the first computing device, the second instructions to the mixed reality device to display the operation of the mixed reality robot in a scene of the second display.

In some embodiments, the method further includes: displaying, by the mixed reality device, a log of the instructions of the first program in the scene of the second display.

In some embodiments, the robotic training system further includes a second computing device, wherein the second computing device includes a processor, a non-transitory computer readable medium having stored thereon instructions executable by the processor, a second program, and a third display, and wherein the method further includes: connecting the first computing device to the second computing device; receiving, by the second computing device, a second input to control the simulated robot and the mixed reality robot; determining, by the second computing device, a third instruction to control the operation of the simulated robot based on the input and a fourth instruction to control the operation of the mixed reality robot; transmitting, by the second computing device, the third instruction and fourth instruction to the first computing device; controlling, by the first computing device, the operation of the simulated robot and the mixed reality robot based on the third and fourth instructions.

In some embodiments, the robotic training system further includes an industrial robot, and wherein the method further includes: connecting, by the second computing device, to the industrial robot; wherein transmitting the third instruction to the first computing device further includes transmitting the third instruction to the industrial robot to control the industrial robot.

In some embodiments, receiving, by the first computing device, the input to command the simulated robot of the first program further includes: determining, by the first computing device, a boundary associated with the mixed reality robot; receiving, by the first computing device, a plurality of images of an object and the mixed reality robot captured by the camera; determining, by the first computing device, an interaction between the object and the boundary.

In some embodiments, the object includes a hand of a user, and wherein the interaction includes a hand gesture.

In some embodiments, a system includes: a first computing device, the first computing device including: a processor, a non-transitory computer readable medium having stored thereon instructions executable by the processor, a first program, the first program including a user input interface, a simulated robot, and a mixed reality robot, a touchscreen display; and a mixed reality device, the mixed reality device including: camera, a second display; wherein the first computing device determines a first instruction to control the simulated robot based on at least one input at the user input interface; wherein the first computing device determines a second instruction to control the mixed reality robot based on the at least one input; wherein the first computing device transmits the second instruction to the mixed reality device to display the mixed reality robot on the second display.

In some embodiments, the system further includes: an industrial robot; and a second computing device; wherein the second computing device includes: a processor, a non-transitory computer readable medium having stored thereon instructions executable by the processor, a second program wherein the second program includes a second user input interface; wherein the second computing device includes being communicatively connected to the first computing device; wherein the first computing device further includes determining a third instruction based on the at least one input, and wherein the first computing device transmits the third instruction to the second computing device; wherein the third instructions control an operation of the industrial robot.

In some embodiments, the system further includes: a first calibration marker disposed at a first position in a scene of the user; and a second calibration marker disposed at a second position in a scene of the user; wherein the first position and the second position include being positioned a fixed distance apart, the fixed distance determined by the first computing device; wherein the at least one input includes initiating a calibration of the simulated robot and the mixed reality robot; wherein the mixed reality robot moves from the first position to the second position, the first computing device calibration the simulated robot and the mixed reality robot based on the mixed reality robot moving from the first position to the second position.

In some embodiments, the mixed reality robot includes being defined by a boundary; and wherein an interaction between an object and the boundary includes the at least one input.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a schematic diagram of a system, according to some embodiments.

FIG. 2 is a schematic diagram of the system, according to some embodiments.

FIG. 3 is a view of the simulated program, according to some embodiments.

FIG. 4 is a perspective view of the scene of the mixed reality device, according to some embodiments.

FIG. 5 is a perspective view of a mixed reality robot of the system, according to some embodiments.

FIG. 6 is a perspective view of the mixed reality robot of the system, according to some embodiments.

FIG. 7 is a flow diagram of a method, according to some embodiments.

FIG. 8 is a flow diagram of the method, according to some embodiments.

FIG. 9 is a flow diagram of the method, according to some embodiments.

FIG. 10 is a flow diagram of the method, according to some embodiments.

FIG. 11 is a flow diagram of the method, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

As used herein “embedded” means that a first material is distributed throughout a second material.

According to various aspects of the present disclosure, a method and system are discussed below for a robotic training system using mixed reality. Various embodiments presented herein provide for remote robotic training systems without a physical robot at the location of the user operating the mixed reality robot.

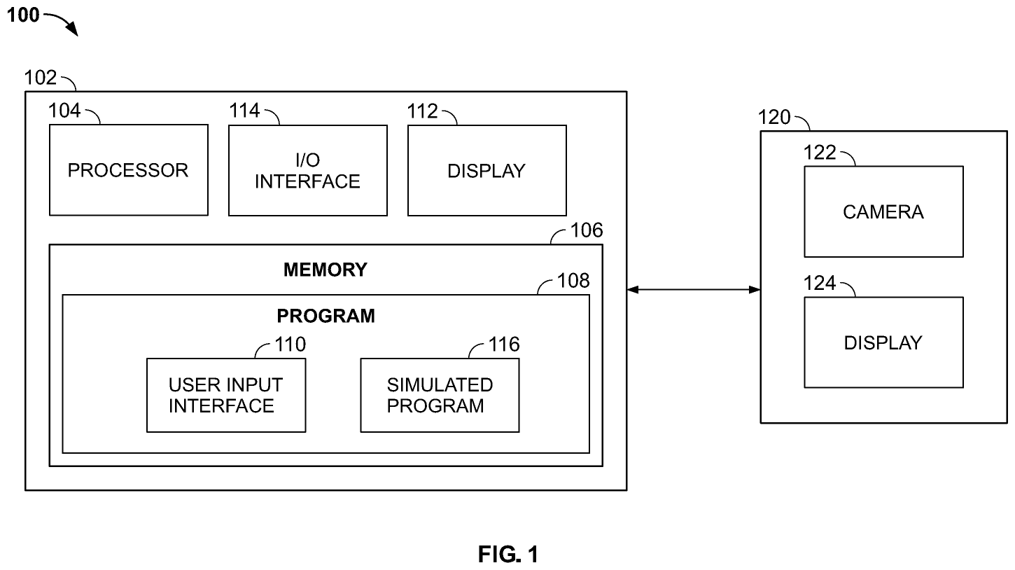

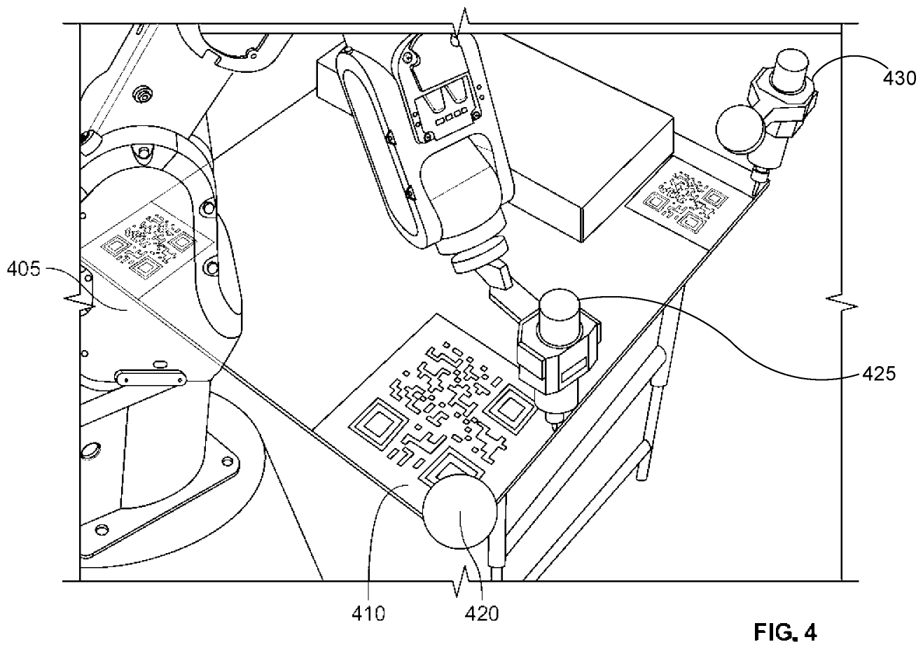

FIG. 1 is a schematic diagram of a system 100, according to some embodiments. The system 100 can include a first computing device 102 and a mixed reality device 120. In some embodiments, the first computing device 102 can include a processor 104, a memory 106, a first program 108, and a first display 112. In some embodiments, the mixed reality device 120 can include a camera 122 and a second display 124. In some embodiments, the first computing device 102 can connect to the mixed reality device 120 and transmit information between the first computing device 102 and the mixed reality device 120. The first computing device 102 can cause the mixed reality device 120 to display a mixed reality robot 405 in a real-world scene of the mixed reality device 120. Further, the mixed reality device 120 can capture an image, or plurality of images, of a scene of the mixed reality device 120, transmit the images, or plurality of images, to the first computing device 102, and display an image of the mixed reality robot 405 on the second display 124 based on information received from the first computing device 102. In some embodiments, the first computing device 102 can include any of a plurality of components to operate a program stored in a memory 106, display 112 an interface 110, receive an input, and connect to a mixed reality device 120 to display a mixed reality robot 405 (FIG. 4) in a real-world scene.

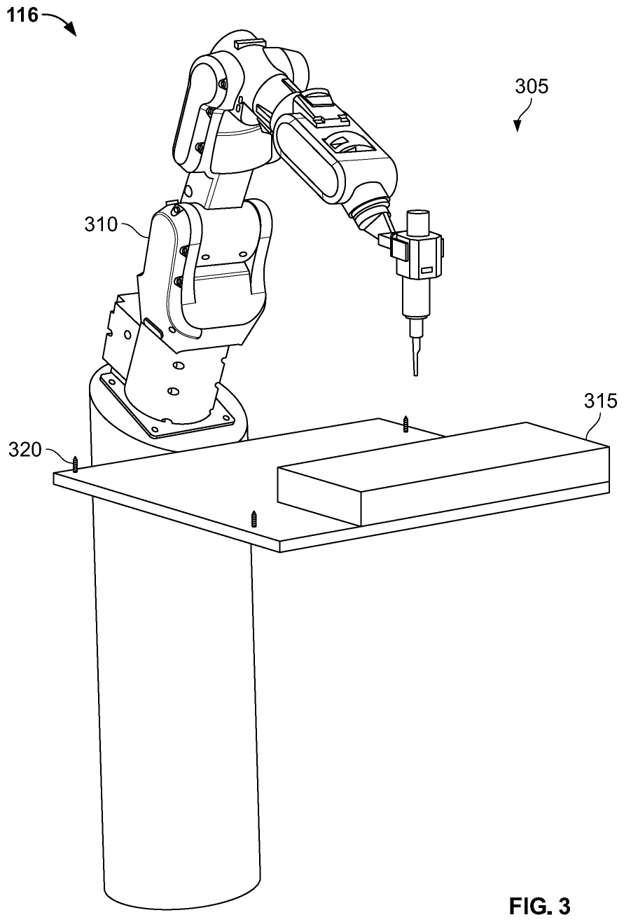

In some embodiments, the first computing device 102 can include the processor 104. The processor 104 controls an operation of the computer, including executing programs stored in the memory 106. The first processor 104 can execute the instructions stored in the memory 106 effective to control the first program 108, including instructions to the mixed reality device 120 to display a mixed reality scene. In some embodiments, the processor 104 can include any of a plurality of processors 104 capable of executing the first program 108, connecting to the mixed reality device 120 to send and receive data, displaying a user input interface 110 onto a display, receiving an input from a user on the user input interface 110, and operating a simulated robot 310 (FIG. 3) and the mixed reality robot 405 (FIG. 4).

In some embodiments, the first computing device 102 can include the memory 106. In some embodiments, the memory 106 can include a non-transitory computer-readable medium having stored thereon instructions executable by the processor 104. In some embodiments, the memory 106 can include the first program 108. In some embodiments, the memory 106 can include any of a plurality of databases stored thereon containing any of a plurality of information for the first computing device 102 to control the first program 108, the mixed reality device 120, a simulated program 116, any other components of the first computing device 102 and combinations thereof. In some embodiments, the memory 106 can include an objects database. the objects database can include any of a plurality of objects including simulated objects, mixed reality objects, objects defined by a user, and combinations thereof. In some embodiments, the objects database can include preloaded objects from any of a plurality of sources including, but not limited to, the mixed reality device 120.

In some embodiments, the first computing device 102 can include the first display 112. In some embodiments, the first computing device 102 can display an image, or plurality of images, on the first display 112. In some embodiments, the first display 112 can display the first program 108, the user input interface 110, the simulated program 116, the mixed reality robot 405, a command log for the first program 108, images, or a plurality of images of the mixed reality device 120, other images, and combinations thereof. In some embodiments, the first display 112 can include a touchscreen panel to receive an input from the user, the input being received by the first computing device 102 to control an operation of the first computing device 102. The touchscreen display of the first computing device 102 allows the user operating the mixed reality device 120 to input commands to control the mixed reality robot 405 on the first computing device 102 without requiring additional third-party components, such as an external teach pendant controller. Further, the virtual teach pendant, the simulated robot 310, the command log for the simulated robot 310, and other features displayed by the user input interface 110 on the first display 112 can provide real-time feedback to the user on the operation of the simulated robot 310 and the mixed reality robot 405. Integrating the virtual teach pendant into the first computing device 102 reduces the number of components of the system, allows the user to control both the simulated program 116 and the mixed reality elements, and provides a visual reference for the user that can also be displayed by the second display 124 of the mixed reality device 120. Thus, in some embodiments, the first computing device 102 can further transmit data relating to the user input interface 110 to display the user input interface 110 as a mixed reality element in the real-world scene. The user can provide inputs to the mixed reality user input interface 110 to control the operation of the first program 108, the simulated program 116, the mixed reality robot 405, and combinations thereof.

In some embodiments, the first computing device 102 can include the first program 108 stored in the memory 106. In some embodiments, the first program 108 of the first computing device 102 can include a user input interface 110 and a simulated program 116. In some embodiments, the first program 108, when executed by the first processor 104, can cause the first computing device 102 to display a user input interface 110 on the first display 112, operate the simulated program 116 including the simulated robot 310 and the mixed reality robot 405, and cause the mixed reality device 120 to display the mixed reality robot 405 and other mixed reality objects on the second display 124 of the mixed reality device 120. In some embodiments, the first computing device 102 can use the first program 108 to send and receive data between the first computing device 102 and the mixed reality device 120. In some embodiments, the first computing device 102 can transmit instructions to the mixed reality device 120 to display a mixed reality image on the display 124. In some embodiments, the mixed reality image can include the mixed reality robot, the mixed reality objects, a mixed reality display panel, other markers and objects, and combinations thereof.

In some embodiments, the first computing device 102 can include the user input interface 110. In some embodiments, the first program 108 can include the user input interface 110. The user input interface 110 can receive an input, or a plurality of inputs, from the user to cause the first computing device 102 to execute a function based on the input. For example, the user can provide an input to move the robot head downward by pulling down on a joystick displayed by the user input interface 110, and the first computing device 102 can receive the input and cause the first program 108 to move the head of the simulated robot 310 and the mixed reality robot 405 down. In some embodiments, the user input interface 110 can be displayed on the first display 112 for the user and can control the operation of the first computing device 102, the first program 108, the simulated program 116, the mixed reality robot 405, other parts of the first program 108, and combinations thereof. In some embodiments, the user input interface 110 can include a teach pendant displayed on the first display 112. In some embodiments, the user input interface 110 can receive user inputs from an external device connectable to the first computing device 102. In some embodiments, the external device connected to the first computing device 102 can include a keyboard, mouse, stylus, stylus pad, mobile phone, PDA, tablet, other devices, and combinations thereof. Further, in some embodiments, the external device can connect to the first computing device 102 by any of a plurality of methods including wired connection, Wi-Fi, Bluetooth, HDMI, CDMA, LTE, Orthogonal frequency-division multiplexing (OFDM) including 5G, other connection methods, and combinations thereof. In some embodiments, the user input interface 110 can include an external robot teach pendant connected to the first computing device 102.

In some embodiments, the first computing device 102 can include the simulated program 116. In some embodiments, the first program 108 of the first computing device 102 can include the simulated program 116. In some embodiments, the simulated program 116 can include a simulated environment 305 and a simulated robot 310 operating in the simulated environment 305. In some embodiments, the first computing device 102 can control the operation of the simulated program 116. In some embodiments, the first computing device 102 can receive the user input and determine instructions based on the user input to control the operation of the simulated program 116, the simulated environment 305, the simulated robot 310, other components, and combinations thereof. In some embodiments, the first computing device 102 controlling the simulated robot 310 by providing instructions to the simulated program 116 can also cause the first computing device 102 to control the mixed reality device 120 to display the mixed reality robot 405 and an operation of the mixed reality robot 405. Consequently, in some embodiments, the first computing device 102 controlling the operation of the simulated program 116 and the simulated robot 310 can further cause the first computing device 102 to display the operation of the mixed reality robot 405 by the mixed reality device 120. In some embodiments, the control of the mixed reality robot 405 can be based, at least in part, on the operation of the simulated robot 310 in the simulated program 116. In some embodiments, the simulated program 116 can include the mixed reality objects displayed by the mixed reality device 120 including the mixed reality robot 405.

In some embodiments, the first computing device 102 can receive the input to command the operation of the simulated robot 310 and the mixed reality robot 405. In some embodiments, the first computing device 102 can receive the user input and determine a first instruction to control the operation of the simulated robot 305 based on the input. In some embodiments, the first instruction can control the operation of the simulated robot 310 and the mixed reality robot 405. In some embodiments, the first computing device 102 can further determine a second instruction to control the operation of the mixed reality robot 405. In some embodiments, the first instructions can include the second instructions. In other embodiments, the second instruction can be based, at least in part, on the first instruction. In some embodiments, the second instruction can be further based on a feedback from the simulated robot 310 operating in the first program 108.

In some embodiments, the first computing device 102 can include an input-output interface 114. The input-output interface 114 can include any of a plurality of communication components to allow the first computing device 102 the communicate with other components of the first computing device 102, external devices including the mixed reality device 120, other computers, and combinations thereof. In some embodiments, the input-output interface 114 can connect the first computing device 102 to the mixed reality device 120. Therefore, in some embodiments, the first computing device 102 can use the input-output interface 114 to communicate with the mixed reality device 120 to, in part, display the images or sequence of images from the camera 122, display the mixed reality robot, display the mixed reality objects, transmit user inputs, other signals, and a combination thereof. In some embodiments, the input-output interface 114 can connect the first computing device 102 to a network 180. In some embodiments, the first computing device 102 can use the input-output interface 114 to connect to a second computing device 132 as will be further discussed below. In some embodiments, the first computing device 102 can connect to a server or network by using the input-output interface 114 to send and receive information to the server or network.

In some embodiments, the first computing device 102 can include a communication port or antennae to allow the first computing device 102 to communicate with other devices and/or networks. In some embodiments, the antennae and other communication ports can be located on the input-output interface 114. In some embodiments, input-output interface 114 can include a WWAN radio using WWAN protocol selected from the group consisting of a third generation partnership project (3GPP) long term evolution (LTE) standard and an Institute of Electrical and Electronics Engineers (IEEE) 802.16 standard. In some embodiments, the input-output interface 114 can include a WLAN radio using a WLAN protocol selected from the group consisting of an IEEE 802.11 standard, an IEEE 802.15 standard, a Bluetooth standard, a Wireless DisplayPort standard, a WiGig standard, an Ultra-Wideband (UWB) standard, a Wireless HD standard, a Wireless Home Digital Interface (WHDI) standard.

In some embodiments, the first computing device 102 and the mixed reality device 120 can be at a first location. In some embodiments, the first computing device 102 can be associated with a first user at the first location and the mixed reality device 120 can be a wearable device worn by the first user at the first location. In some embodiments, the first computing device 102 can include a mobile device held by the first user and the mixed reality device 120 can include a wearable device worn by the user.

In some embodiments, the system 100 can include the mixed reality device 120. In some embodiments, the mixed reality device 120 can include the camera 122. The camera 122 can capture a scene of the environment of the mixed reality device 120 in view of the camera 122. In some embodiments, the camera 122 can be a first camera 122. In some embodiments, the mixed reality device 120 can include a plurality of cameras to capture a plurality of images in the scene of the mixed reality device 120 and/or of the first user wearing the mixed reality device 120. In some embodiments, the image captured by the camera 122 can be a single image. In other embodiments, the image captured by the camera 122 can include a plurality of images, a video, and a combination thereof. In some embodiments, the system 100 can include a third camera connected to the mixed reality device 120, the first computing device 102, and combinations thereof. In some embodiments, the mixed reality device 120 can further include a processor, memory, GPU, other components, and combinations thereof to capture images of the mixed reality device 120, process the image, or images, captured by the camera 122, and display mixed reality elements on the second display 124.

In some embodiments, the mixed reality device 120 can transmit the image to the first computing device 102. In some embodiments, the mixed reality device 120 can receive the image captured by the camera 122, convert the image to data, and transmit the data to the first computing device 102. The first computing device 102 can receive the data from the mixed reality device 120. In some embodiments, the mixed reality device 120 can also determine other information based on the image, or images, such as positional data, reference locations, depth, scale, other factors, and combinations thereof, and transmit the information to the first computing device 102. In some embodiments, the first computing device 102 can receive the image data and determine such information based on the image data. In some embodiments, the camera 122 can capture images of physical objects in the scene of the user. In some embodiments, the first computing device 102 can receive the images and identify the presence of the objects in the scene. In some embodiments, the first computing device 102 can receive the images captured by the camera 122 to determine an interaction between objects of the scene and the mixed reality scene. In some embodiments, the objects can include physical objects such as calibration points. In some embodiments, the objects can include objects of the user including, but not limited to, a user's hand. In some embodiments, the camera 122 can capture an image of the object. The first computing device 102 can receive the image of the object and can determine that the object's may be interacting with an object of the mixed reality scene, including the mixed reality robot. Consequently, in some embodiments, the first computing device 102 can detect the object interaction and can control the operation of the mixed reality scene or the simulated program 116 based on the object interaction.

In some embodiments, the camera 122 of the mixed reality device 120 can capture an image, or images, of the scene of the mixed reality device 120. The first computing device 102 can receive the information from the mixed reality device 120 and can determine instructions to display the mixed reality robot based on the image. The first computing device 102 can transmit instructions to the mixed reality device 120 relating to the display of the mixed reality robot 405, other mixed reality objects, and combinations thereof. For example, the mixed reality device 120 can capture the image of the room and transmit the image(s) of the room to the first computing device 102. The first computing device 102 receives the image and determines, based on the image and the size of the mixed reality robot 405 model, that the mixed reality robot 405 can be positioned at one of a plurality of positions in the room. The first computing device 102 can transmit instructions to the mixed reality device 120 to display the mixed reality robot at one of the determined locations. The mixed reality device 120 can receive the instructions and display the mixed reality robot at the position. The user can view the mixed reality robot at the position. In some embodiments, the mixed reality robot 405 displayed by the mixed reality device 120 and the first computing device 102 can be scaled based upon the real-world scene. For example, if the default size of the mixed reality robot 405 does not fit the dimensions of the real-world scene, the first computing device 102 can scale the display of the mixed reality robot 405 based on a user input of the desired scale or the first computing device 102 can determine the adjusted scale at which to display the mixed reality robot 405.

In some embodiments, the second display 124 can include a transparent display. In some embodiments, the second display 124 can include a semi-transparent display. In some embodiments, the second display 124 can be a non-transparent display. In some embodiments, the second display 124 can display an image of a mixed reality scene over a real-world scene, both the mixed reality scene and the real-world scene viewable by the user. In some embodiments, the camera 122 can capture the image of the scene of the first user and display the captured image, or images, on the second display 124 along with the image of the mixed reality scene. The transparent display can allow the mixed reality device 120 to display the mixed reality scene over the real-world scene viewable by the first user.

In some embodiments, the mixed reality device 120 can include, but is not limited to, a processor, non-transitory computer-readable medium having stored thereon instructions executable by the processor, buttons, speakers, sensors, antennas, other components, and combinations thereof. In some embodiments, the mixed reality device 120 can include any device capable of connecting to a first computing device 102 and displaying the mixed reality scene in the real-world scene. In some embodiments, the mixed reality device 120 can be a wearable device wearable by the first user. For example, the first user can wear the wearable device on a head of the first user. The mixed reality device 120 can include, for example, a Microsoft's HoloLens, Magic Leap's One, Google Glasses, or any other mixed reality device including a wearable device with a transparent screen.

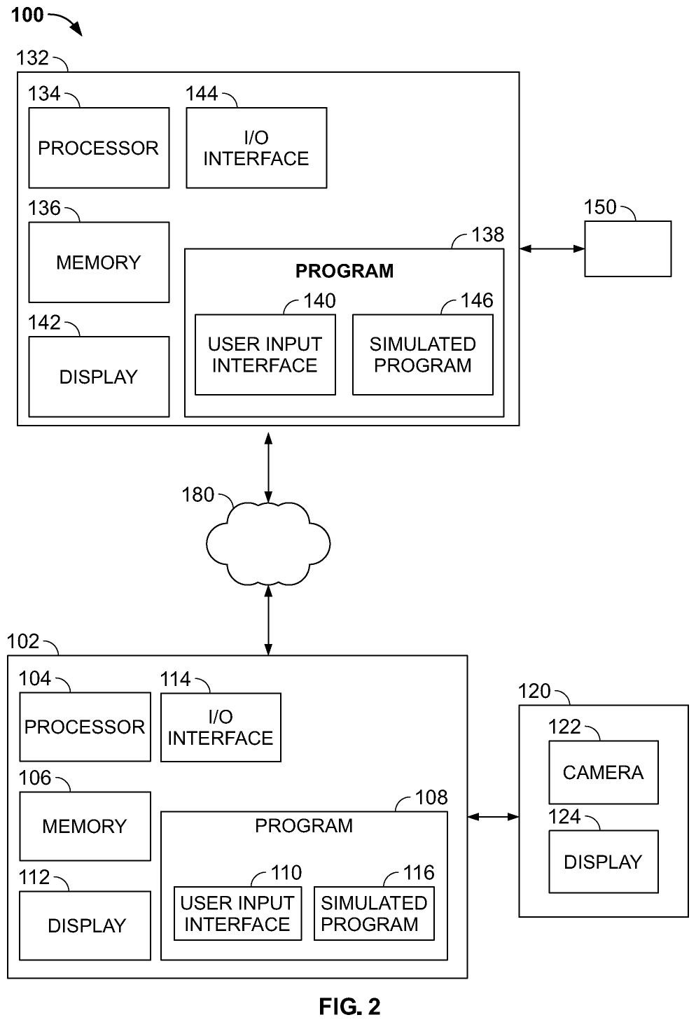

FIG. 2 is a schematic diagram of the system 100, according to some embodiments. In some embodiments, the system 100 can further include a second computing device 132. The second computing device 132 can include a second processor 134, a second memory 136, a second program 138, a third display 142. In some embodiments, the second program 138 can include second user input interface 140 and a second simulated program 146. In some embodiments, the second computing device 132 can include any of a plurality of components to allow the second computing device 132 to connect to the first computing device 102, the network 180, a industrial robot 150, and combinations thereof and to control the first computing device 102, the second computing device 132, the industrial robot 150, and combinations thereof.

In some embodiments, the second computing device 132 can include the second processor 134 and the second memory 136. The second processor 134 can be structured to execute instructions stored in the second memory 136. In some embodiments, the second memory 136 can include a non-transitory computer-readable medium having stored thereon instructions executable by the processor. In some embodiments, the second memory 136 can include the second program 138 stored thereon.

The second computing device 132 can include the third display 142. In some embodiments, the third display 142 can include a touchscreen display to display an image from the second computing device 132 and to receive an input from the user. Consequently, in some embodiments, the second computing device 132 can be connected to an input device capable of receiving an input from the user to control the second computing device 132. In some embodiments, the input device can include a keyboard, touchpad, laptop, tablet, mobile device, other devices capable of receiving and sending an input, and a combination thereof.

In some embodiments, the second computing device 132 can display the image, or images, showing the second program 138, the second user input interface 140, the second simulated program 146, the simulated program 116, the mixed reality robot of the first computing device 102, other images, and a combination thereof. For example, the second computing device 132 can connect to the first computing device 102 and the third display 142 can display the images being displayed by the first computing device 102 on the first display 112. Alternatively, the second computing device 132 can display the image captured by the camera 122 of the mixed reality device 120 and show the virtual robot operating in the scene of the mixed reality device 120 as viewed by the user.

In some embodiments, the second computing device 132 can include the second program 138. In some embodiments, the second program 138 can be the same program as the first program 108. In some embodiments, the second program 138 can be a different program from the first program 108. In some embodiments, each of the first program 108 and/or the second program 138 can include elevated rights accessible by a user with credentials for the elevated rights. For example, the second computing device 132 may be the computing device of a second user at a second location, the second user can use the second computing device 132 and/or the second program 138 to connect to the first computing device 102 and/or the first program 108 to control the first computing device 102 including the simulated environment 305, the simulated robot 310, and the mixed reality robot 405.

In some embodiments, the second program 138 can include a second user input interface 140 and the second simulated program 146. In some embodiments, the second user input interface 140 can include a virtual teach pendant displayed on the third display 142. In some embodiments, the second user input interface 140 can be operated by the user to control and operate a simulated robot of the second computing device 132, the simulated robot of the first computing device 102, the mixed reality robot of first computing device 102, and combinations thereof. In some embodiments, the second user input interface 140 can include an external input device connectable to the second computing device 132. The external input device can receive a user input and transmit the input to the second computing device 132. The second computing device 132 can receive the input and determine, based on the input, any of a plurality of actions to control the operation of the second computing device 132, the second program 138, the second simulated program 146, the first computing device 102, other devices, and combinations thereof.

In some embodiments, the second computing device 132 can be connected to the first computing device 102. In some embodiments, the second computing device 132 can connect to a server or network and connect to the first computing device 102 through the server or network. In some embodiments, the second computing device 132 can connect to the first computing device 102 and send and receive information between the first computing device 102 and the second computing device 132. Therefore, in some embodiments, the second computing device 132 can control the operation of the first computing device 102 including, but not limited to, the first program 108, the simulated program 116, the mixed reality robot, and a combination thereof.

In some embodiments, the second program 138 can include the second simulated program 146. In some embodiments, the second simulated program 146 can include a second simulated environment 305, a second simulated robot 310, and a combination thereof. In some embodiments, the second computing device 132 can control the second simulated program 146 including the second simulated environment 305 and the second simulated robot 310. In some embodiments, the simulated program 116 can be the same or similar program as the second simulated program 146. In some embodiments, the simulated program 116 and the second simulated program 146 can be the different programs having different coding to perform different functions. In some embodiments, the simulated program 116 and the second simulated program 146 can include a plurality of user profiles. Each of the plurality of user profiles can include different privileges to allow each user profile to perform different operations. Therefore, in some embodiments, a first user of the first computing device 102 can have a first user profile and a second user of the second computing device 132 can have a second user profile. The first user profile may allow the first user to connect to the first computing device 102 and the mixed reality device 120. The second user profile may allow the second user to connect to the second computing device 132, the first computing device 102, the mixed reality device 120, the industrial robot 150, and a combination thereof. Further, in some embodiments, the second user profile may allow the first computing device 102 to connect and control the operation of the industrial robot 150.

In some embodiments, the instructions to control the second simulated program 146 by the second computing device 132 can also transmit the instructions to the first computing device 102 to control the operation of the first simulated robot 310, the mixed reality robot 405, and combinations thereof. Further, in other embodiments, instructions from the first computing device 102 to control the operation of the mixed reality robot 405, the first simulated robot 310, and combinations thereof can be sent by the first computing device 102 to the second computing device 132 to control the operation of the second computing device 132, including the second simulated robot 310, the mixed reality robot 405, the industrial robot 150, and a combination thereof.

In some embodiments, the second computing device 132 can include the second input output interface 144. In some embodiments, the second computing device 132 can connect to the server, the network 180, the first computing device 102, an industrial robot 150, and a combination thereof. In some embodiments, the second computing device 132 can connect to the first computing device 102 and transmit commands, images, or sequence of images between the second computing device 132 and the first computing device 102. In some embodiments, the second computing device 132 can use the second input output interface 144 to connect to the first computing device 102 through the network 180. In some embodiments, the input-output interface 114 can include a communication port or antennae to allow the first computing device 102 to communicate with other devices and/or networks. In some embodiments, the input-output interface 114 can include a WWAN radio using WWAN protocol selected from the group consisting of a third generation partnership project (3GPP) long term evolution (LTE) standard and an Institute of Electrical and Electronics Engineers (IEEE) 802.16 standard. In some embodiments, the input-output interface 114 can include a WLAN radio using a WLAN protocol selected from the group consisting of an IEEE 802.11 standard, an IEEE 802.15 standard, a Bluetooth standard, a Wireless DisplayPort standard, a WiGig standard, an Ultra-Wideband (UWB) standard, a Wireless HD standard, a Wireless Home Digital Interface (WHDI) standard.

In some embodiments, the second computing device 132 can be at the first location. In some embodiments, the second computing device 132 can be located at a second location. In some embodiments, the second location can be remotely located from the first location. For example, the first location can be the home of a first user, while the second location can be the office of an industrial robot trainer.

In some embodiments, the system 100 can include the industrial robot 150. In some embodiments, the industrial robot 150 can be connected to the second computing device 132. In some embodiments, the industrial robot 150 can be connected to the first computing device 102 through the second computing device 132, the network 180, and a combination thereof. In some embodiments, the second computing device 132 controlling the operation of the second simulated program 146 can also control the operation of the industrial robot 150 based on the operation of the second simulated robot of the second simulated program 146. Further, in some embodiments, instructions received from the first computing device 102 to control the second simulated program 146 can include instructions to control the operation of the industrial robot 150.

In some embodiments, the second computing device 132 can control an operation of the industrial robot 150 connected to the second computing device 132. Further, in some embodiments, the second computing device 132 can control the operation of the simulated program 116 of the first computing device 102, the second simulated program 146, the mixed reality robot of the first computing device 102, the industrial robot 150, and a combination thereof. In other embodiments, the first computing device 102 can control the operation of the mixed reality robot, the simulated program 116, the second simulated program 146, the industrial robot 150, and a combination thereof. In some embodiments, one of the first computing device 102 and the second computing device 132 can communicate with the other of the first computing device 102 and the second computing device 132 to control the operation of the simulated program 116, the second simulated program 146, the mixed reality robot, the industrial robot 150, other objects, and a combination thereof.

In some embodiments, the industrial robot 150 can be at the location of the first computing device 102. In some embodiments, the industrial robot 150 can be at the location of the second computing device 132. In some embodiments, the industrial robot 150 can be at a third location remote from the first location and the second location. In some embodiments, the second computing device 132 can include the controller for the industrial robot 150 to control an operation of the industrial robot 150.

FIG. 3 is a view of the simulated program 116, according to some embodiments. FIG. 4 is a perspective view of the mixed reality robot 405, according to some embodiments. FIGS. 3-4 will be discussed collectively unless specific reference is made to a particular figure.

Referring to FIG. 3, in some embodiments, the simulated program 116 can include the first simulated environment 305 and the first simulated robot 310. In some embodiments, the first computing device 102 can control the simulated program 116 to display a simulated environment 305 and a simulated robot 310 operating in the simulated environment 305. In some embodiments, the first computing device 102 can receive an input from a user, determine, based at least in part on the input, the instructions to control the operation of the robot, and transmit the instructions to the simulated program 116 to control the operation of the simulated environment 305, the simulated robot 310, and a combination thereof. In some embodiments, the command to the simulated program 116 can also be sent to the mixed reality device 120 to control the operation of the mixed reality robot. In some embodiments, the input can be received by the mixed reality device 120 and transmitted to the first computing device 102 to command the operation of the simulated robot, the mixed reality robot, the industrial robot 150, and a combination thereof.

In some embodiments, the simulated program 116 can also include a simulated object 315 in the simulated environment 305. In some embodiments, the simulated object 315 can be associated with a physical object of the real-world scene. Consequently, in some embodiments, the user can define the simulated object 315 in the first program 108 to use in the simulated program 116. In some embodiments, the simulated object 315 can be created by using a third program to design the simulated object 315 and the data representing the simulated object 315 can be saved into the memory 106 of the first computing device 102 and used by the first program 108. In some embodiments, the user can create the simulated object 315 by using the first program 108.

In some embodiments, the first computing device 102 can calibrate the simulated robot 310, the mixed reality robot 405, and combinations thereof. In some embodiments, the simulated robot 310 can be calibrated to the mixed reality robot 405. Calibration ensures proper coordination and accurate control of the mixed reality robot 405 and the simulated robot 310. Therefore, proper calibration provides that instructions to control the operation of the simulated robot 310 and the mixed reality robot 405 will result in substantially similar operation between the simulated robot 310 and the mixed reality robot 405.

In some embodiments, the first computing device 102 can include calibration of the mixed reality robot 405 and the simulated robot 310 upon an initiation of the first program 108. In some embodiments, the user can initiate the calibration. In some embodiments, the first computing device 102 can initiate the calibration if an error is detected between the operation of the simulated robot 310 and the mixed reality robot 405. In some embodiments, the first computing device 102 can determine that a calibration is needed based, at least in part, on the operation of the simulated robot 310 in the simulated program 116 and the movement of the mixed reality robot 405 in the scene of the mixed reality device 120 as viewable on the second display 124.

In some embodiments, the simulated program 116 can include calibration points 320. In some embodiments, the first computing device 102 can calibrate the simulated robot 310 and the mixed reality robot 405 by determining calibration points for the simulated robot 310 and the mixed reality robot 405. In some embodiments, the first computing device 102 can use two calibration points. In some embodiments, the first computing device 102 can use three calibration points. In some embodiments, the first computing device 102 can use more than three calibration points. In some embodiments, the first computing device 102 can determine the number of calibration points based on the axes being calibrated. The first computing device 102 determines a calibration location for each of the calibration points. In some embodiments, the first computing device 102 can display the calibration points for the simulated robot 310 including calibration point positions, distances, angles, other information, and a combination thereof. Consequently, in some embodiments, the user can position calibration markers in the real-world scene based on the calibration points in the simulated program 116 and shown by the first computing device 102. For example, the first computing device 102 can provide instructions shown on the first display 112 for positioning the calibration markers on a surface, the first calibration marker and the second calibration marker on a first axis a first distance apart, and the third calibration marker on a second axis, perpendicular to the first axis, and a second distance from the first marker and the second marker. Then first computing device 102 can then calibrate the simulated robot 310 and the mixed reality robot 405 based on the known locations of the first calibration marker, the second calibration marker, and the third calibration marker to align the simulated robot 310 to the mixed reality robot 405.

Referring to FIG. 4, the mixed reality device 120 can receive instructions from the first computing device 102 to cause the second display 124 to display the mixed reality robot 405, the calibration point 420, other mixed reality objects, and combinations thereof. In some embodiments, the second display 124 can display the movement and operation of the mixed reality robot 405 based on the instructions from the first computing device 102, the user input to the first computing device 102, the user input based on an interaction with the mixed reality environment including the mixed reality robot 405, and combinations thereof.

In some embodiments, the first computing device 102 can send instructions to control the movement of the mixed reality robot 405 and the second display 124 can display the mixed reality robot 405 in a scene of the first user. Consequently, in some embodiments, based on instructions from the first computing device 102 to move the mixed reality robot 405 from a first position 425 to a second position 430, the mixed reality device 120 can receive the instructions and cause the second display 124 to display the movement of the mixed reality robot 405. In some embodiments, movement of the mixed reality robot 405 can include displaying the mixed reality robot 405 at the first position 425 and displaying the robot, or a portion of the robot, in a second position 430, the second position 430 being the end position of the mixed reality robot 405 based on the instructions received by the first computing device 102. Consequently, a user can observe and anticipate the movement of the mixed reality robot 405. In some embodiments, the first position can be represented by the current position of the mixed reality robot 405. In some embodiments, the second position can include the end position of the mixed reality robot 405 based on the instructions received by the first computing device 102.

In some embodiments, the mixed reality robot 405 can be calibrated by the first computing device 102. In some embodiments, the mixed reality device 120 can capture the image of the calibration marker 410. The first computing device 102 can receive the image from the mixed reality device 120 and can then determine a calibration point 420 based on the image of the calibration marker 410. In some embodiments, the mixed reality robot 405 can be calibrated by positioning a plurality of calibration marker 410 in the real-world scene. In some embodiments, each of the plurality of calibration markers can be associated with calibration points 320 in the simulated environment 305. In some embodiments, the first program 108 can generate an image of the calibration marker 410 and display the calibration markers 410 on the first display 112 or some other display connected to the first computing device 102. In some embodiments, the image of the calibration marker 410 can be printed and used in the real-world scene. In some embodiments, the calibration marker 410 can include an image including a calibration point for the mixed reality robot 405. In some embodiments, the calibration marker 410 can be a scannable QR code. In some embodiments, the calibration marker 410 can include other images including, but not limited to, barcodes, text, other coded images including readable instructions, and combinations thereof.

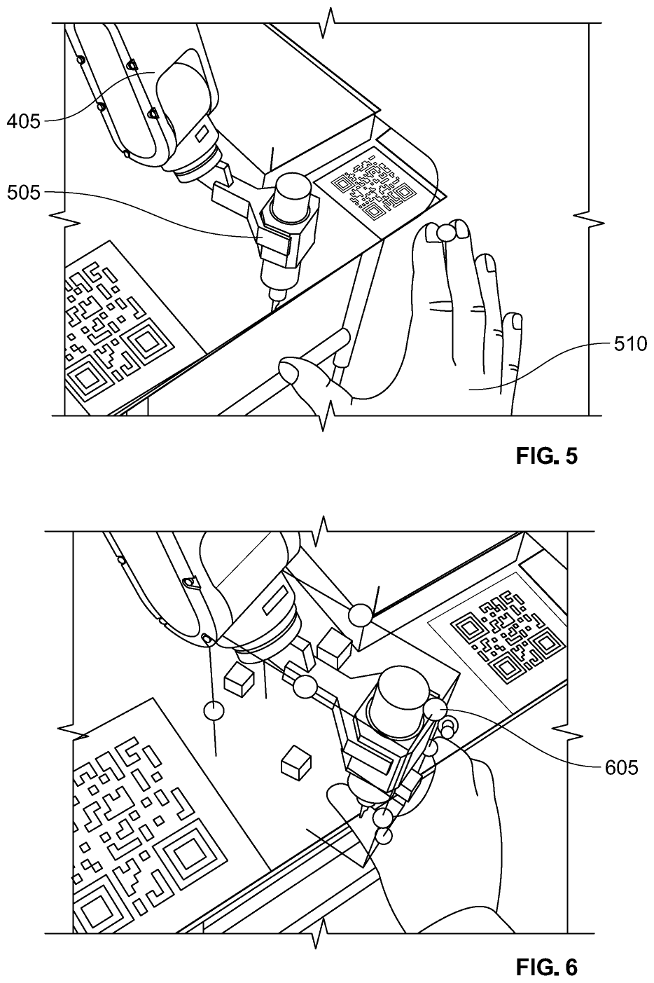

FIG. 5 is a view of the display 124 on the mixed reality device 120, according to some embodiments. FIG. 6 is a view of the display 124 on the mixed reality robot 120, according to some embodiments. FIGS. 5-6 will be discussed collectively unless specific reference is made to a particular figure.

Referring to FIG. 5, in some embodiments, each mixed reality object can include a boundary 505 defined by the first computing device 102. The boundary 505 generally defines the shape of the mixed reality object viewed through the second display 124. In some embodiments, the boundary 505 can include the outer shape of the mixed reality objects, including the mixed reality robot 405. In some embodiments, each of the mixed reality objects displayed by the mixed reality device 120 can include the boundary 505 that can define the shape of each object. In some embodiments, an interaction with the boundary 505 can provide an input to the first computing device 102 to control the mixed reality objects. In some embodiments, the boundary 505 can be associated with the shape of the mixed reality objects rather than defining the shape of the mixed reality objects.

In some embodiments, the first computing device 102 can receive images captured by the mixed reality device 120 of an object 510 interaction with the boundary 505 of a mixed reality object. In some embodiments, the first computing device 102, the mixed reality device 120, and combinations thereof, can determine an interaction between the mixed reality object, for example the mixed reality robot 405, and an object 510 based, in part, on the mixed reality device 120 capturing images of the object 510 interacting with the boundary 505 of the mixed reality robot 405. For example, the object 510 can push the mixed reality robot 405 in a particular direction based on the object 510 pressing on the boundary 505 of the mixed reality robot 405 in a scene captured by the mixed reality device 120. In some embodiments, the user input to the first computing device 102 can be based on the interaction between the boundary 505 of the mixed reality object and the object 510. Consequently, in some embodiments, the first computing device 102 can determine instructions to control the operation of the simulated robot 310, the mixed reality robot 405, and a combination thereof, based on the object 510 interaction with the boundary 505 of the mixed reality objects, similar to receiving an input at the user input interface 110.

Referring to FIG. 6, in some embodiments, the boundary 505 can be a first boundary 505 and the first computing device 102 can determine a second boundary 605 associated with the mixed reality objects. In some embodiments, the second boundary 605 can extend beyond the dimensions of the mixed reality objects and the first boundary 505. The second boundary 605 can be represented by any of a plurality of shapes, lines, figures, other graphical representations, and combinations thereof. In some embodiments, the boundary 605 can be an outline shape around the boundary 505 the mixed reality object. In some embodiments, the second boundary 605 may not be displayed by the mixed reality device 120 unless the first computing device 102 determines an interaction between the object 510 and the second boundary 605. In some embodiments, the interaction between the object 510 and the second boundary 605 can cause the first computing device 102 to transmit instructions to display the second boundary 605. In some embodiments, the first computing device 102 can determine the interaction between the object 510 and the second boundary 605 to be an input command to the first computing device 102. Consequently, the first computing device 102 can receive the input from the mixed reality device 120 based on the interaction of the object 510 and the second boundary 605, determine instructions based on the input, and transmit the instructions to the simulated program 116, the simulated robot 310, the mixed reality robot 405, and combinations thereof, to control the operation of the simulated robot 310 and the mixed reality robot 405.

In some embodiments, the object 510 can include any of a plurality of objects to interact with the mixed reality robot 405. In some embodiments, the object 510 can include mixed reality objects, calibration markers, a hand, other body parts, other objects, and combinations thereof.

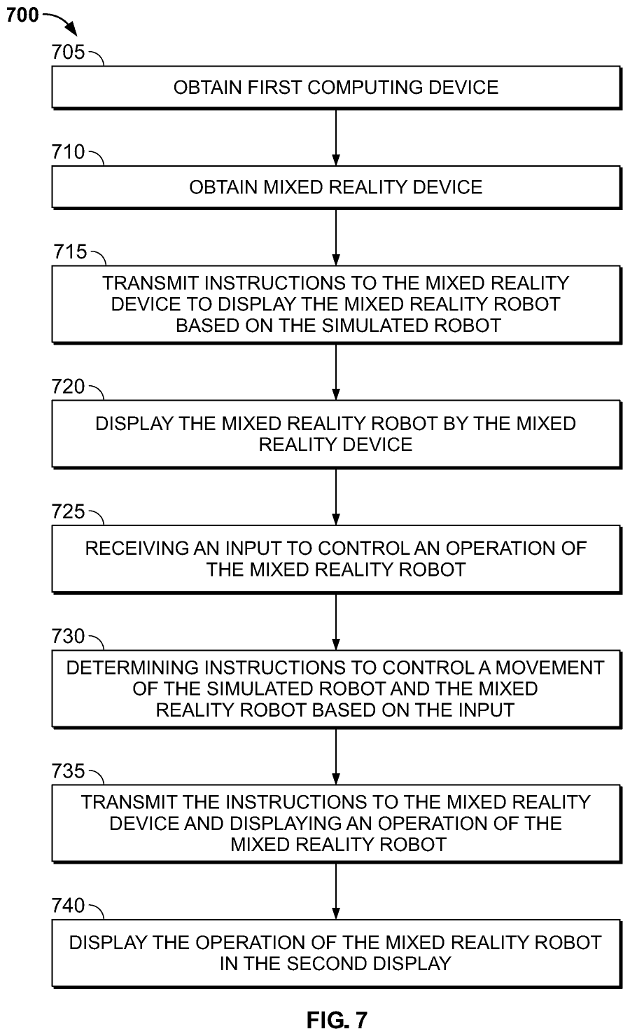

FIG. 7 is a flow diagram of a method 700, according to some embodiments. In some embodiments, the method 700 relates to operating a mixed reality robotic training system, the mixed reality robotic training system can include a first computing device 102 and a mixed reality device 120.

At 705, the method 700 can include obtaining the first computing device 102. In some embodiments, the first computing device 102 can be at the first location of the first user. In some embodiments, the first computing device 102 can include the processor 104, the memory 106, the first program 108, the first display 112, the user input interface 110, and the simulated program 116.

In some embodiments, the first program 108 can include the simulated program 116 with the simulated robot 310 operating in the simulated environment 305. In some embodiments, the first program 108 can further control the operation of the mixed reality robot 405 and other mixed reality objects displayed by the mixed reality device 120.

In some embodiments, the first display 112 can include a touchscreen display. The touchscreen display can display images and receive an input by a user at the first computing device 102. In some embodiments, the first program 108 can include a user input interface 110 to receive the input to the first computing device 102 at the first display 112 or some other input device. In some embodiments, the first computing device 102 can display the user input interface 110 on the first display 112. In some embodiments, the first computing device 102 can display other images on the first display 112. In some embodiments, the first computing device 102 can receive the image from the camera 122 and overlay onto the image the mixed reality image and display the image on the first display 112.

At 710, the method 710 can include obtaining the mixed reality device 120. In some embodiments, the mixed reality device 120 can be located at the first location. In some embodiments, each of the first computing device 102 and the mixed reality device 120 can be at the location of the first user. In some embodiments, the mixed reality device 120 can include a camera 122 and a second display 124. In some embodiments, the mixed reality device 120 can be connectable to the first computing device 102. In some embodiments, the mixed reality device 120 can be hard wired into the first computing device 102. In some embodiments, the mixed reality device 120 can connect to the first computing device 102 by Wi-Fi, Bluetooth, other wireless connection schemes, and combinations thereof.

At 715, the method 700 can receiving, by the first computing device 102, a first input on the user input interface 110 to control an operation of the mixed reality robot 405. In some embodiments, the first input can be received at the first display 112, the first display 112 including a touchscreen display. In some embodiments, the first input can be received on an external input device. In some embodiments, the first input can be received based on an interaction with the mixed reality robot 405 as will be further described below.

At 720, the method 700 can include determining, by the first computing device 102, a first instruction to control the mixed reality robot 405 based on the first input. In some embodiments, the first computing device 102 can determine instructions to control the simulated robot 310 and the mixed reality robot 405 based on the first input. In some embodiments, the first computing device 102 can determine a first instruction to control the simulated robot 310 and a second instruction to control the mixed reality robot 405. In some embodiments, the first instruction and the second instruction can include the same instructions. In some embodiments, the first instruction can control each of the simulated robot 310 and the mixed reality robot 405. In some embodiments, the first instruction can include instructions for the mixed reality device 120 to display the mixed reality robot 405 in the scene of the second display 124. The image on the mixed reality device 120 being viewable by the user wearing the mixed reality device 120. In some embodiments, the first program 108 determines the instructions to control each of the simulated robot 310 and the mixed reality robot 405 based on the first input.

In some embodiments, the input can include a user input at the user input interface 110. In some embodiments, the input can be on an external input device. In some embodiments, the input can be from an interaction of the object 510 with the boundary 505 of the mixed reality robot 405. In some embodiments, the input can be the interaction of the object 510 with the second boundary 605 of the mixed reality robot 405. In some embodiments, the input can be from at the simulated program 116. In some embodiments, the first input can include at least one input at the first computing device 102. In some embodiments, the first input can include a plurality of inputs.

At 725, the method 700 can include transmitting the first instructions to the mixed reality device 120. In some embodiments, the first instructions can further include instructions to control the operation of the simulated robot 310. In some embodiments, the first instructions determined by the first computing device 102 can be transmitted to each of the simulated robot 310 and the mixed reality robot 405 to control each of the simulated robot 310 and the mixed reality robot 405.

At 730, the method 700 can include displaying, by the mixed reality device 120, the operation of the mixed reality robot 405 based on the first instruction. In some embodiments, the operation of the mixed reality robot 405 can include the movement of the mixed reality robot 405 in the real-world scene on the second display 124. In some embodiments, operation of the mixed reality robot 405 can include the calibration of the mixed reality robot 405 to the simulated robot 310. In some embodiments, the operation of the mixed reality robot 405 can include other operational functions of the mixed reality robot 405 including movements stemming from user inputs at the user input interface 110, detected by the mixed reality device 120, or from some other device.

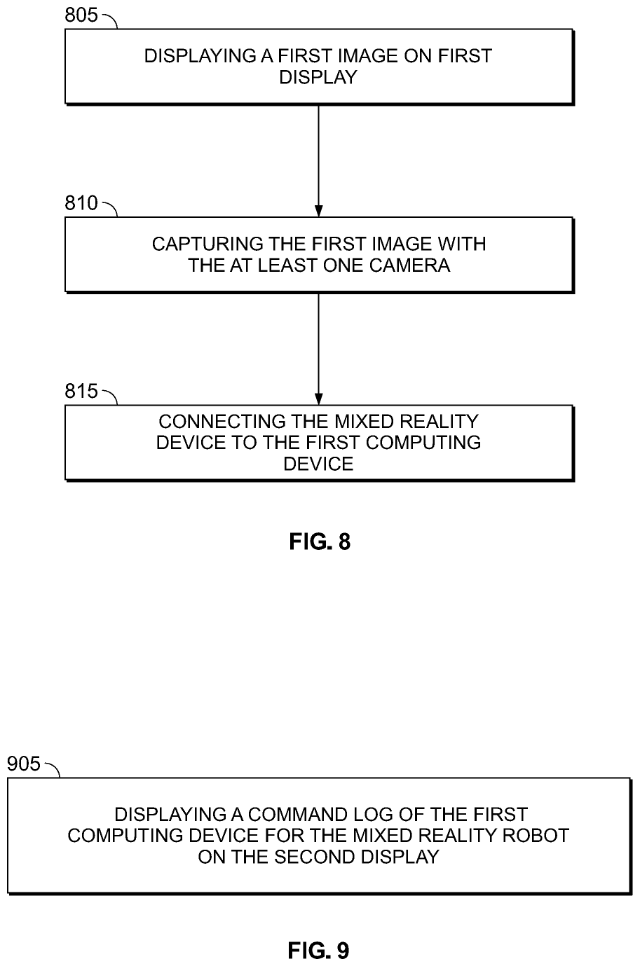

FIG. 8 is a flow diagram of the method 700, according to some embodiments. At 805, the method 800 can include displaying, by the first computing device 102, a first image identifying the first computing device 102 on the first display 112. In some embodiments, the first image can include data representing an identification of the first computing device 102. In some embodiments, the first image can include an IP address of the first computing device 102. In some embodiments, the first image can include other identifying information of the first computing device 102. In some embodiments, the mixed reality device 120 can pair to the first computing device 102 by detecting the first image with the camera 122. In some embodiments, the first image can include a coded image containing information from the first computing device 102. In some embodiments, the first image can include a QR code or other scannable image.

At 810, the method 700 can include capturing, by the mixed reality device 120, the first image with the camera 122. In some embodiments, the mixed reality device 120 can capture the image and the instructions coded into the image can cause the mixed reality device 120 to connect to the first computing device 102.

At 815, the method 700 can include connecting, by the first computing device 102, the mixed reality device 120 to the first computing device 102. The first computing device 102 connects to the mixed reality device 120 to communicate with each of the first computing device 102 and the mixed reality device 120 including receiving data related to images captured by the mixed reality device 120 and data relating to displaying the operation of the mixed reality robot 405.

FIG. 9 is a flow diagram of the method 800, according to some embodiments. At 905, the method 700 can include displaying, by the mixed reality device 120, a log of the commands of the first computing device 102 for the mixed reality robot 405 on the second display 124. In some embodiments, the log can be a mixed reality object displayed on the second display 124. In some embodiments, the log can include commands to the simulated robot 310 and the mixed reality robot 405. In some embodiments, the log of commands can be displayed on the first display 112 and as an object displayed on the second display 124.

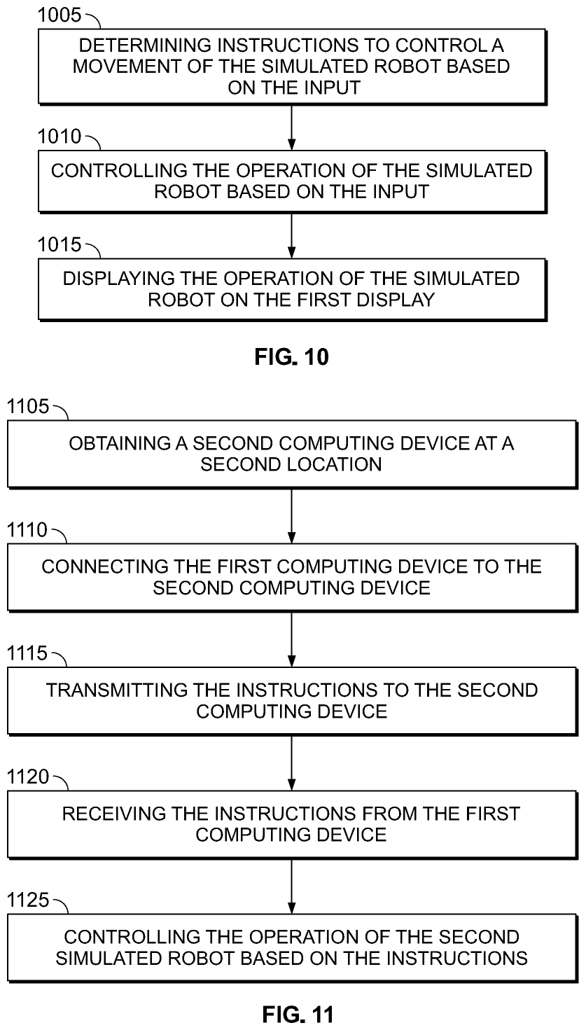

FIG. 10 is a flow diagram of the method 700, according to some embodiments. In some embodiments, at 1005, the method 700 can include obtaining the second computing device 132. In some embodiments, the second computing device 132 can be at the first location. In some embodiments, the second computing device 132 can be at a second location remote from the first computing device 102.

In some embodiments, at 1010, the method 700 can include connecting the first computing device 102 to the second computing device 132. In some embodiments, the first computing device 102 and connect to the second computing device 132. In some embodiments, the second computing device 132 can include a second program 138 to communicate with the first computing device 102. In some embodiments, the second computing device 132 can include the industrial robot 150. In some embodiments, the industrial robot 150 can be connected to the second computing device 132.

In some embodiments, at 1015, the method 700 can include receiving, by the second computing device 132, the first instruction from the first computing device 102. In some embodiments, the first computing device 102 can transmit the first instruction to the second computing device 132. In some embodiments, the first instruction received by the second computing device 132 can include instructions on the operation of the simulated robot to be displayed on the third display 142 of the second computing device 132. In some embodiments, the first instruction can control the operation of the industrial robot 150 connected to the second computing device 132.

In some embodiments, at 1020, the method 700 can include displaying, by the second computing device 132, the operation of the simulated robot based on the first instruction in the second program 138 based on the first instruction.

FIG. 11 is a flow diagram of the method 700, according to some embodiments. In some embodiments, at 1105, the method 700 can include capturing, by the mixed reality device 120, a plurality of images of an object 510 in the scene of the mixed reality robot and transmit the plurality of images to the first computing device 102. In some embodiments, the object 510 can include any of a plurality of objects. In some embodiments, the object 510 can include a body part of the user. In some embodiments, the object 510 can include a hand of the user.

In some embodiments, at 1110, the method 700 can include determining, by the first computing device 102, an interaction between the object 510 and the mixed reality robot 405 based on the plurality of images. In some embodiments, the interaction can include the object 510 approaching a boundary 505 of the mixed reality robot 405. In some embodiments, the interaction can include the object 510 exerting a force on the boundary 505 as capture by the plurality of images of the mixed reality device 120.

In some embodiments, at 1115, the method 700 can include determining, by the first computing device 102, a third instruction based on the interaction.

In some embodiments, at 1120, the method 700 can include controlling, by the first computing device 102, the operation of the simulated robot 310 and the operation of the mixed reality robot 405 based on the third instruction. In some embodiments, the operation can include a movement of part of the mixed reality robot 405, a calibration of the mixed reality robot 405, a repositioning of the mixed reality robot 405, other operations, and combinations thereof.

In some embodiments, at 1125, the method 700 can include displaying, by the mixed reality device 120, the operation of the mixed reality robot 405 based on the third instruction. The mixed reality device 120 can receive the third instruction from the first computing device 102, the mixed reality device 120 displaying the movement of the mixed reality robot 405 based at least in part on the third instruction.

In some embodiments, at 1130, the method 700 can include displaying, by the mixed reality device 120, the boundary when the object 510 approaches the boundary 505. In some embodiments, the boundary 505 can be displayed with the object 510 contacts the boundary 505. In some embodiments, the boundary 505 can be displayed when the object 510 contacts the boundary 505 for a predetermined period of time.

### Aspects

Various Aspects are described below. It is to be understood that any one or more of the features recited in the following Aspect(s) can be combined with any one or more other Aspect(s).

In some aspects, the techniques described herein relate to a method of operating a mixed reality robotic training system, the mixed reality robotic training system including a first computing device and a mixed reality device, the method including: obtaining the first computing device, wherein the first computing device includes a processor, a non-transitory computer-readable medium having stored thereon instructions executable by the processor, a first program, a first display, and a user input interface; obtaining the mixed reality device, wherein the mixed reality device includes a camera and a second display; receiving, by the first computing device, a first input on the user input interface to control an operation of the mixed reality robot; determining, by the first computing device, a first instruction to control the mixed reality robot based on the first input; transmitting, by the first computing device, the first instruction to the mixed reality device; and displaying, by the mixed reality device, the operation of the mixed reality robot based on the first instruction.

In some aspects, the techniques described herein relate to a method, the method further includes: displaying, by the first computing device, a first image identifying the first computing device on the first display; capturing, by the mixed reality device, the first image with the camera; and connecting the mixed reality device to the first computing device.

In some aspects, the techniques described herein relate to a method, further including: displaying, by the mixed reality device, a command log of the first computing device in the scene of the mixed reality robot.

In some aspects, the techniques described herein relate to a method, wherein determining a first instruction to control the mixed reality robot based on the first input further includes: determining, by the first computing device, a first instruction to control the operation of the simulated robot; determining, by the first computing device, a second instruction to control the operation of the mixed reality robot based on the first instruction.

In some aspects, the techniques described herein relate to a method, wherein the robotic training system further includes a second computing device, wherein the second computing device includes a processor, a non-transitory computer-readable medium having stored thereon instructions executable by the processor, a second program, and wherein the method further includes:
obtaining the second computing device, connecting the first computing device to the second computing device; receiving, by the second computing device, the first instruction from the first computing device; and displaying, by the second computing device, the operation of the simulated robot in the second program based on the first instruction.

In some aspects, the techniques described herein relate to a method, wherein the robotic training system further includes an industrial robot, and the method further includes: connecting the industrial robot to the second computing device; controlling, by the second computing device, the operation of the industrial robot based on the first instruction from the first computing device.

In some aspects, the techniques described herein relate to a method, wherein the method further includes: receiving, by the second computing device, a second input at the second computing device; determining, by the second computing device, a second instruction to control the operation of the simulated robot; transmitting, by the second computing device, the second instruction to the first computing device to control the operation of the simulated robot and the mixed reality robot; and controlling, by the first computing device, the operation of the simulated robot and the mixed reality robot based on the second instruction.

In some aspects, the techniques described herein relate to a method, further including: capturing, by the mixed reality device, a plurality of images of an object in the scene of the mixed reality robot and transmitting the plurality of images to the first computing device; determining, by the first computing device, an interaction between the object and the mixed reality robot based on the plurality of images; determining, by the first computing device, a third instruction based on an interaction; controlling, by the first computing device, the operation of the simulated robot and the operation of the mixed reality robot based on the third instruction; displaying, by the mixed reality device, the operation of the mixed reality robot based on the third instruction.

In some aspects, the techniques described herein relate to a method, further including: determining, by the first computing device, a boundary associated with the mixed reality robot, displaying, by the mixed reality device, the boundary when the object approaches the boundary; wherein determining the interaction between the object and the mixed reality robot includes determining the object interaction with the boundary.

In some aspects, the techniques described herein relate to a method, further including: wherein the object includes a hand of a user; and wherein the interaction includes a hand gesture.

In some aspects, the techniques described herein relate to a method for remote operation of a mixed reality robot training system, the robotic training system including a first computing device and a mixed reality device, the first computing device including a processor, a non-transitory computer readable medium having stored thereon instructions executable by the processor, a first program, and a first display, and wherein the mixed reality device includes camera and a second display, the first computing device and the mixed reality device at a first location, the method including: receiving, by the first computing device, an input to command a simulated robot of the first program; determining, by the first computing device, a first instruction to control the operation of the simulated robot and a second instruction to control the operation of the mixed reality robot based on the input; controlling, by the first computing device, the operation of the simulated robot based on the first instruction and the operation of the mixed reality robot based on the second instruction; transmitting, by the first computing device, the second instructions to the mixed reality device to display the operation of the mixed reality robot in a scene of the second display.

In some aspects, the techniques described herein relate to a method, further including: displaying, by the mixed reality device, a log of the instructions of the first program in the scene of the second display.

In some aspects, the techniques described herein relate to a method, wherein the robotic training system further includes a second computing device, wherein the second computing device includes a processor, a non-transitory computer readable medium having stored thereon instructions executable by the processor, a second program, and a third display, and wherein the method further includes: connecting the first computing device to the second computing device; receiving, by the second computing device, a second input to control the simulated robot and the mixed reality robot; determining, by the second computing device, a third instruction to control the operation of the simulated robot based on the input and a fourth instruction to control the operation of the mixed reality robot; transmitting, by the second computing device, the third instruction and fourth instruction to the first computing device; controlling, by the first computing device, the operation of the simulated robot and the mixed reality robot based on the third and fourth instructions.

In some aspects, the techniques described herein relate to a method, wherein the robotic training system further includes an industrial robot, and wherein the method further includes: connecting, by the second computing device, to the industrial robot; wherein transmitting the third instruction to the first computing device further includes transmitting the third instruction to the industrial robot to control the industrial robot.

In some aspects, the techniques described herein relate to a method, wherein receiving, by the first computing device, the input to command the simulated robot of the first program further includes: determining, by the first computing device, a boundary associated with the mixed reality robot; receiving, by the first computing device, a plurality of images of an object and the mixed reality robot captured by the camera; determining, by the first computing device, an interaction between the object and the boundary.

In some aspects, the techniques described herein relate to a method, wherein the object includes a hand of a user, and wherein the interaction includes a hand gesture.

In some aspects, the techniques described herein relate to a system including: a first computing device, the first computing device including: a processor, a non-transitory computer readable medium having stored thereon instructions executable by the processor, a first program, the first program including a user input interface, a simulated robot, and a mixed reality robot, a touchscreen display; and a mixed reality device, the mixed reality device including: camera, a second display; wherein the first computing device determines a first instruction to control the simulated robot based on at least one input at the user input interface; wherein the first computing device determines a second instruction to control the mixed reality robot based on the at least one input; wherein the first computing device transmits the second instruction to the mixed reality device to display the mixed reality robot on the second display.

In some aspects, the techniques described herein relate to a system, wherein the system further includes: an industrial robot; and a second computing device; wherein the second computing device includes: a processor, a non-transitory computer readable medium having stored thereon instructions executable by the processor, a second program wherein the second program includes a second user input interface; wherein the second computing device includes being communicatively connected to the first computing device; wherein the first computing device further includes determining a third instruction based on the at least one input, and wherein the first computing device transmits the third instruction to the second computing device; wherein the third instructions control an operation of the industrial robot.

In some aspects, the techniques described herein relate to a system, further including: a first calibration marker disposed at a first position in a scene of the user; and a second calibration marker disposed at a second position in a scene of the user; wherein the first position and the second position include being positioned a fixed distance apart, the fixed distance determined by the first computing device; wherein the at least one input includes initiating a calibration of the simulated robot and the mixed reality robot; wherein the mixed reality robot moves from the first position to the second position, the first computing device calibration the simulated robot and the mixed reality robot based on the mixed reality robot moving from the first position to the second position.

In some aspects, the techniques described herein relate to a system, further including: wherein the mixed reality robot includes being defined by a boundary; and wherein an interaction between an object and the boundary includes the at least one input.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1. A method of operating a mixed reality robotic training system, the mixed reality robotic training system comprising a first computing device and a mixed reality device, the method comprising:
obtaining the first computing device,
wherein the first computing device comprises a processor, a non-transitory computer-readable medium having stored thereon instructions executable by the processor, a first program, a first display, and a user input interface;
obtaining the mixed reality device,
wherein the mixed reality device comprises a camera and a second display;
receiving, by the first computing device, a first input on the user input interface to control an operation of the mixed reality robot;
determining, by the first computing device, a first instruction to control the mixed reality robot based on the first input;
transmitting, by the first computing device, the first instruction to the mixed reality device; and
displaying, by the mixed reality device, the operation of the mixed reality robot based on the first instruction.

2. The method of claim 1, the method further comprises:
displaying, by the first computing device, a first image identifying the first computing device on the first display;
capturing, by the mixed reality device, the first image with the camera; and
connecting the mixed reality device to the first computing device.

3. The method of claim 1, further comprising:
displaying, by the mixed reality device, a command log of the first computing device in the scene of the mixed reality robot.

4. The method of claim 1, wherein determining a first instruction to control the mixed reality robot based on the first input further comprises:
determining, by the first computing device, a first instruction to control the operation of the simulated robot;
determining, by the first computing device, a second instruction to control the operation of the mixed reality robot based on the first instruction.

5. The method of claim 4, wherein the robotic training system further comprises a second computing device, wherein the second computing device comprises a processor, a non-transitory computer-readable medium having stored thereon instructions executable by the processor, a second program, and wherein the method further comprises:
obtaining the second computing device,
connecting the first computing device to the second computing device;
receiving, by the second computing device, the first instruction from the first computing device; and
displaying, by the second computing device, the operation of the simulated robot in the second program based on the first instruction.

6. The method of claim 5, wherein the robotic training system further comprises an industrial robot, and the method further comprises:
connecting the industrial robot to the second computing device;
controlling, by the second computing device, the operation of the industrial robot based on the first instruction from the first computing device.

7. The method of claim 5, wherein the method further comprises:
receiving, by the second computing device, a second input at the second computing device;
determining, by the second computing device, a second instruction to control the operation of the simulated robot;
transmitting, by the second computing device, the second instruction to the first computing device to control the operation of the simulated robot and the mixed reality robot; and
controlling, by the first computing device, the operation of the simulated robot and the mixed reality robot based on the second instruction.

8. The method of claim 1, further comprising:
capturing, by the mixed reality device, a plurality of images of an object in the scene of the mixed reality robot and transmitting the plurality of images to the first computing device;
determining, by the first computing device, an interaction between the object and the mixed reality robot based on the plurality of images;
determining, by the first computing device, a third instruction based on an interaction;
controlling, by the first computing device, the operation of the simulated robot and the operation of the mixed reality robot based on the third instruction;
displaying, by the mixed reality device, the operation of the mixed reality robot based on the third instruction.

9. The method of claim 8, further comprising:
determining, by the first computing device, a boundary associated with the mixed reality robot,
displaying, by the mixed reality device, the boundary when the object approaches the boundary;
wherein determining the interaction between the object and the mixed reality robot comprises determining the object interaction with the boundary.

10. The method of claim 8, further comprising:
wherein the object comprises a hand of a user; and
wherein the interaction comprises a hand gesture.

11. A method for remote operation of a mixed reality robot training system, the robotic training system comprising a first computing device and a mixed reality device, the first computing device comprising a processor, a non-transitory computer readable medium having stored thereon instructions executable by the processor, a first program, and a first display, and wherein the mixed reality device comprises camera and a second display, the first computing device and the mixed reality device at a first location, the method comprising:
receiving, by the first computing device, an input to command a simulated robot of the first program;
determining, by the first computing device, a first instruction to control the operation of the simulated robot and a second instruction to control the operation of the mixed reality robot based on the input;
controlling, by the first computing device, the operation of the simulated robot based on the first instruction and the operation of the mixed reality robot based on the second instruction;
transmitting, by the first computing device, the second instructions to the mixed reality device to display the operation of the mixed reality robot in a scene of the second display.

12. The method of claim 11, further comprising:
displaying, by the mixed reality device, a log of the instructions of the first program in the scene of the second display.

13. The method of claim 11, wherein the robotic training system further comprises a second computing device, wherein the second computing device comprises a processor, a non-transitory computer readable medium having stored thereon instructions executable by the processor, a second program, and a third display, and wherein the method further comprises:
connecting the first computing device to the second computing device;
receiving, by the second computing device, a second input to control the simulated robot and the mixed reality robot;
determining, by the second computing device, a third instruction to control the operation of the simulated robot based on the input and a fourth instruction to control the operation of the mixed reality robot;
transmitting, by the second computing device, the third instruction and fourth instruction to the first computing device;
controlling, by the first computing device, the operation of the simulated robot and the mixed reality robot based on the third and fourth instructions.

14. The method of claim 13, wherein the robotic training system further comprises an industrial robot, and wherein the method further comprises:
connecting, by the second computing device, to the industrial robot;
wherein transmitting the third instruction to the first computing device further comprises transmitting the third instruction to the industrial robot to control the industrial robot.

15. The method of claim 11, wherein receiving, by the first computing device, the input to command the simulated robot of the first program further comprises:
determining, by the first computing device, a boundary associated with the mixed reality robot;
receiving, by the first computing device, a plurality of images of an object and the mixed reality robot captured by the camera;
determining, by the first computing device, an interaction between the object and the boundary.

16. The method of claim 15, wherein the object comprises a hand of a user, and
wherein the interaction comprises a hand gesture.

17. A system comprising:
a first computing device, the first computing device comprising:
a processor,
a non-transitory computer readable medium having stored thereon instructions executable by the processor,
a first program, the first program comprising a user input interface, a simulated robot, and a mixed reality robot,
a touchscreen display; and
a mixed reality device, the mixed reality device comprising:
camera,
a second display;
wherein the first computing device determines a first instruction to control the simulated robot based on at least one input at the user input interface;
wherein the first computing device determines a second instruction to control the mixed reality robot based on the at least one input;
wherein the first computing device transmits the second instruction to the mixed reality device to display the mixed reality robot on the second display.

18. The system of claim 17, wherein the system further comprises:
an industrial robot; and
a second computing device;
wherein the second computing device comprises:
a processor,
a non-transitory computer readable medium having stored thereon instructions executable by the processor,
a second program
wherein the second program comprises a second user input interface;
wherein the second computing device comprises being communicatively connected to the first computing device;
wherein the first computing device further comprises determining a third instruction based on the at least one input, and wherein the first computing device transmits the third instruction to the second computing device;
wherein the third instructions control an operation of the industrial robot.

19. The system of claim 17, further comprising:
a first calibration marker disposed at a first position in a scene of the user; and
a second calibration marker disposed at a second position in a scene of the user;
wherein the first position and the second position comprise being positioned a fixed distance apart, the fixed distance determined by the first computing device;
wherein the at least one input comprises initiating a calibration of the simulated robot and the mixed reality robot;
wherein the mixed reality robot moves from the first position to the second position, the first computing device calibration the simulated robot and the mixed reality robot based on the mixed reality robot moving from the first position to the second position.

20. The system of claim 19, further comprising:
wherein the mixed reality robot comprises being defined by a boundary; and
wherein an interaction between an object and the boundary comprises the at least one input.
